(19) United States
(12) Patent Application Publication
(10) Pub. No.: US 2002/0178540 A1
(43) Pub. Date: Dec. 5, 2002

(54) Caster assembly having an interchangeable caster cap

(76) Inventors: Richard M. Holbrook, Altadena, CA (US); Darren M. Mark, Valenica, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/163,268

(22) Filed: Jun. 5, 2002

Related U.S. Application Data
(60) Provisional application No. 60/296,251, filed on Jun. 5, 2001.
(60) Provisional application No. 60/296,430, filed on Jun. 5, 2001.

(51) Int. Cl. B60B 33/00

(52) U.S. Cl. 16/18 R

(57) ABSTRACT

The present invention provides a caster assembly having at least one caster wheel attached to a wheel axle that is, in turn, attached to a caster body, wherein the caster body has at least one cap-orientation indexing rib and at least one indention. A connector assembly having at least one indexing slot for receiving the at least one indexing rib of the caster body and at least one detent element for forming an interlocking connection with the at least one indention of the caster body is also to the caster body. The connector assembly is also attached to a caster cap, such that the caster cap is attached to the caster body.

### CROSS-REFERENCE TO RELATED APPLICATION(S)

This application claims priority under 35 U.S.C. §119(e) to U.S. Provisional Application Ser. No. 60/296,430, filed on Jun. 5, 2001 and to U.S. Provisional Application Ser. No. 60/296,251, also filed on Jun. 5, 2001.

The disclosure of U.S. patent application Ser. No. ______ (attorney docket number H367-48515), entitled “CASTER BRAKE ASSEMBLY”, filed on even date herewith is incorporated herein in full by reference as if stated in full herein.

Reference is made to U.S. Design patent application Ser. No. 29/133,111 (“Caster”) filed Nov. 22, 2000.

### FIELD OF THE INVENTION

The present invention is directed to a caster assembly, such as a twin wheel caster, for use with furniture, such as a chair. More particularly, the present invention is directed to a caster assembly having an interchangeable cap.

### BACKGROUND OF THE INVENTION

Casters are typically mounted to the legs or footings of furniture pieces to provide for ease of mobility of the furniture pieces. Casters typically comprise either two wheels (commonly referred to as twin wheel casters) or a single wheel (commonly referred to as single wheel casters). It is sometimes desirable to at least partially cover the wheel or wheels of a caster, for example, to protect the wheel(s) from outside contact, such as from the shoes of persons occupying the particular piece of furniture to which the wheel(s) are attached; and/or to protect the wheel axle and/or other moving parts of the wheel from dust and dirt.

### SUMMARY OF THE INVENTION

The present invention provides a caster assembly comprising at least one caster wheel; a wheel axle attached to the at least one caster wheel; a caster body having at least one cap-orientation indexing rib and at least one indention, wherein the wheel axle is attached to the caster body; a connector assembly attached to the caster body, the connector assembly having at least one indexing slot for receiving the at least one indexing rib of the caster body and at least one detent element for forming an interlocking connection with the at least one indention of the caster body; and a caster cap attached to the connector assembly.

The present invention also provides a method for assembling a caster assembly comprising providing at least one caster wheel; attaching the at least one caster wheel to a wheel axle; attaching the wheel axle to a caster body, wherein the caster body has at least one cap-orientation indexing rib and at least one indention; providing a caster cap having a connector assembly attached thereto, the connector assembly having at least one indexing slot for receiving the at least one indexing rib of the caster body and at least one detent element for forming an interlocking connection with the at least one indention of the caster body; aligning the at least one indexing rib of the caster body with the at least one indexing slot of the connector assembly; and displacing the at least one indexing rib of the caster body within the at least one indexing slot of the connector assembly until the at least one detent element of the connector assembly forms an interlocking connection with the at least one indention of the caster body.

It should be noted that the term “cap” is used herein to represent coverings for casters, including top-only coverings, and top and side coverings, which are also sometimes referred to as “guards”.

### BRIEF DESCRIPTION OF THE DRAWINGS

These and other features of the present invention are more fully set forth in the following description of exemplary embodiments of the invention. The description is presented with reference to the accompanying drawings in which:

FIG. 1 shows a perspective view of a caster assembly according to the present invention, having a caster body before the addition of a caster cap;

FIG. 2 shows a perspective view of a caster assembly according to the present invention, having a caster body and a caster cap;

FIG. 3 shows a perspective view of a caster assembly according to the present invention, having a caster body and an alternative caster cap;

FIG. 4a shows a bottom exploded perspective view of a caster assembly according to the present invention;

FIG. 4b shows a longitudinal cross-sectional view of a connector assembly of a caster cap according to the present invention;

FIG. 4c shows a bottom perspective view of the caster cap of FIG. 4a;

FIG. 5 shows a top exploded perspective view of an alternative caster assembly according to the present invention;

FIG. 6 shows a bottom exploded perspective view of another alternative caster assembly according to the present invention comprising a braking assembly; and

FIG. 7 shows a top exploded perspective view of the caster assembly of FIG. 6.

### DETAILED DESCRIPTION OF THE INVENTION

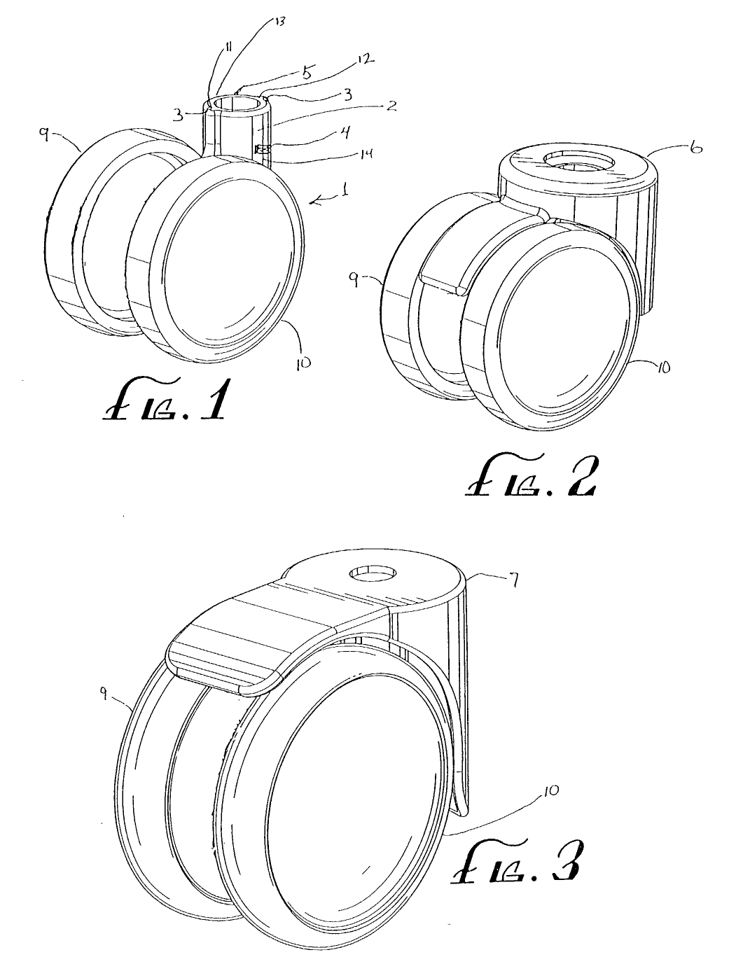

FIG. 1 shows a caster assembly 1, such as a twin-wheel caster, having a caster body 2. The caster body 2 comprises at least one cap-orientation indexing rib 3. In the depicted embodiment, the caster body 2 comprises two cap-orientation indexing ribs 3 disposed on an outer circumference 5 of the caster body 2, for example, on a front edge 11 and a back edge 12 of the outer circumference 5 of the caster body 12. The cap-orientation indexing ribs 3 serve as guides during the assembly of a caster cap (described below) to the caster body 2. The indexing ribs 3 also prevent rotation of the cap and ensure a particular orientation of the cap with respect to the caster body 2 when the cap is assembled on the caster body 2.

It will be understood by a person having ordinary skill in the art that the caster body 2 may comprise a single cap-orientation indexing rib 3 without departing from the spirit of the invention. However, a single rib 3 embodiment provides less assembly-guiding and rotation-inhibiting qualities than an embodiment having two indexing ribs 3. In addition, the caster body 2 may comprise more than two cap-orientation indexing ribs 3 without departing from the spirit of the invention. However, such an embodiment increases the manufacturing cost of the caster assembly 1 without substantially adding to the assembly-guiding and rotation-inhibiting qualities of an embodiment having two indexing ribs 3.

It will be further understood by a person having ordinary skill in the art that in an embodiment wherein two indexing ribs 3 are used, the ribs 3 may be disposed in positions other than on directly opposing sides of the caster body 2, as is shown in FIG. 1, without departing from the spirit of the invention. Similarly, in an embodiment wherein more than two cap-orientation indexing ribs 3 are used, the ribs 3 may be disposed in various configurations around the outer circumference 5 of the caster body 2 without departing from the spirit of the present invention.

As depicted in FIG. 1, the caster body 2 comprises at least one indention 4, which may be an indention or an aperture. In an exemplary embodiment, the caster body comprises two indentions 4, for example on opposing sides 13 and 14 of the caster body 2. It will be understood by a person having ordinary skill in the art that the caster body 2 may comprise one indention 4, two indentions 4 or more than two indentions 4 without departing from the spirit of the present invention. It will be further understood by a person having ordinary skill in the art that the dimensions of the indentions 4 may vary without departing from the spirit of the invention. It will also be understood by a person having ordinary skill in the art that a distance from a top surface of the caster body 2 to the indentions 4 may vary without departing from the spirit of the present invention.

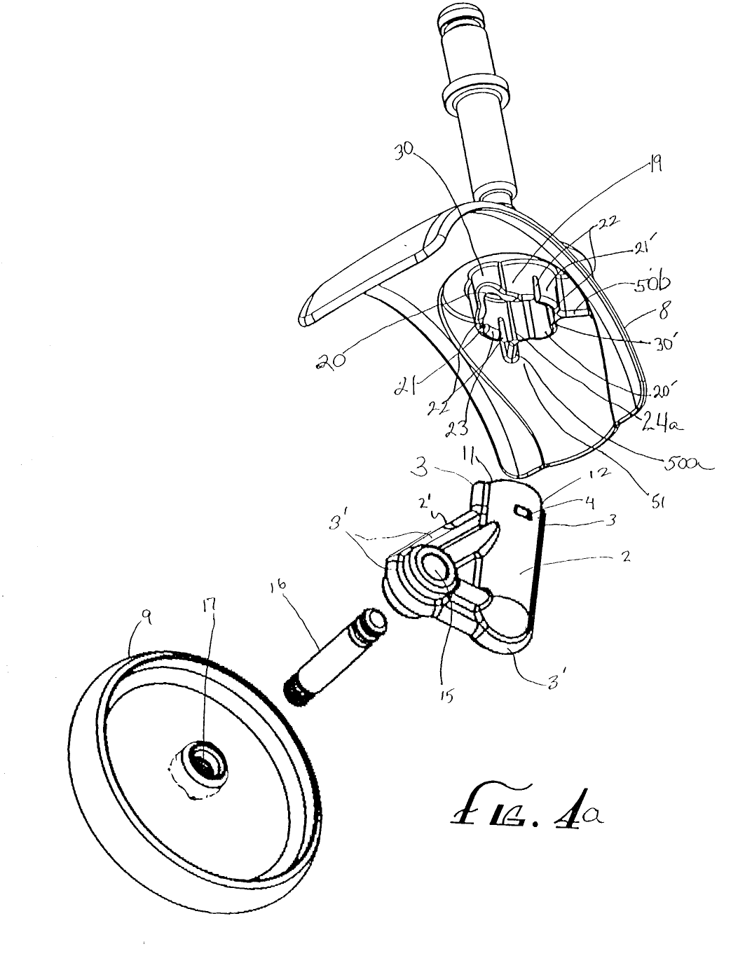

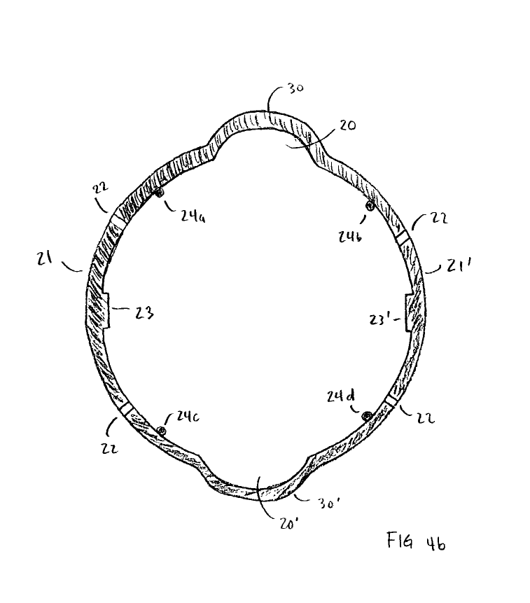

FIGS. 2 and 3 show exemplary caster cap configurations, 6 and 7 respectively, that have been assembled with the caster body 2.

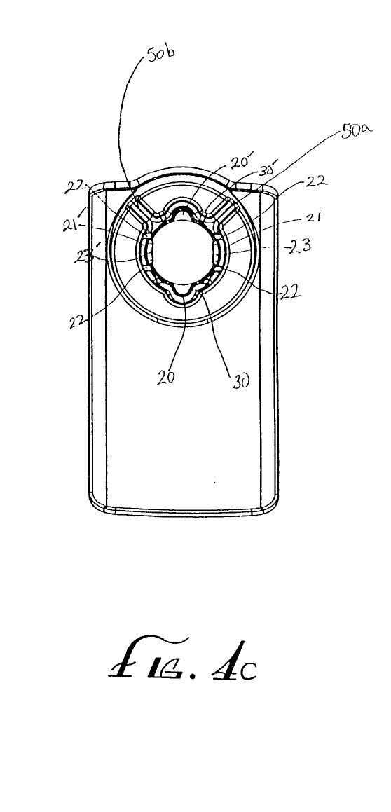

FIG. 4a shows a bottom exploded perspective view of an embodiment of the caster assembly 1 of the present invention, including another exemplary caster cap configuration 8. The cap 8 may comprise a unibody structure, composed of a semi-flexible material such as polypropylene or nylon. In such an embodiment, due to the semi-flexible nature of the material from which the cap 8 is composed, a connector assembly of the cap 8, discussed below, is also semi-flexible.

The caster body 2 may be composed of a rigid material, a semi-rigid material, or a semi-flexible material, among others. For purposes of attachment of the caster body 2 to the connector assembly, discussed below, the caster body 2 may be composed of any suitable material. However, for durability of the caster assembly 1, in which the caster body 2 is assembled, it is preferred that the caster body 2 comprises a durable, rigid material, such as a metal material.

As shown in FIG. 4a, a wheel support 2′ may be attached to the caster body 2. The wheel support 2′ may comprise a bore 15 and an axle 16 that extends through and is mounted within the bore 15, wherein the caster wheel 9 is rotatably mounted to the axle 16. For example, the wheel 9 may be rotatably mounted to the axle 16 by inserting an end of the axle 16 into a hub 17 of the wheel 9. In addition, the wheel 10 may also be similarly rotatably mounted to the axle 16. In an alternative embodiment, the axle 16 may be integrally formed with the caster body 2.

In the depicted embodiment of FIG. 4a, the cap-orientation indexing ribs 3 are disposed on the front and back edge 11 and 12 of the outer circumference 5 of the caster body 2. As can be seen in FIG. 4a, the ribs 3 may be formed as a continuous structure, beginning at the top surface of the caster body 2 on the front edge 11 of the caster body 2, continuing along a spine 3′ of the wheel support 2′ and caster body 2, and ending at the top surface of the caster body 2 on the back edge 12 of the caster body 2.

As shown in FIGS. 4a and 4b, the cap 8 may comprise a connector assembly 19 protruding from an inner surface 51 of the cap 8. In the depicted embodiment, the connector assembly 19 and the caster body 2, which attaches to the connector assembly 19 as described below, are generally cylindrical. However, it should be understood by a person having ordinary skill in the art that the connector assembly 19 and the caster body 2 may have configurations other than cylindrical configurations, such as oblong, square, pentagonal, hexagonal, heptagonal, and octagonal configurations, among others, as well as irregular shapes, such as a generally cylindrical shape having at least one flat edge, among others.

In the depicted embodiment, the connector assembly 19 comprises a front 30 and a back section 30′ and side sections 21 and 21′. The front 30 and back section 30′ may each comprise an indexing slot, 20 and 20′ respectively, for receiving a corresponding cap-orientation indexing rib 3. In the depicted embodiment, the indexing ribs 3 and indexing slots 20 and 20′ are each generally cylindrical. However, the indexing slots 20 and 20′ and the indexing ribs 3 may have any suitable configuration, as long as rotation of the cap 3 with respect to the caster body 2 is inhibited when the indexing ribs 3 and indexing slots 20 and 20′ are engaged. For example, the indexing ribs 3 and indexing slots 20 may be triangular, rectangular, or irregularly shaped, among other configurations. Although the coupling of two indexing ribs 3 with two indexing slots 20 and 20′ has been described, it is also contemplated that the connector assembly 19 may comprise a single indexing slot 20 and the caster body 2 may comprise a single indexing rib 3, such that a coupling of the indexing slot 20 with the rib 3 inhibits a rotation of the cap 8 with respect to the caster body 2 when the cap 8 is attached to the caster body 2. Similarly, the connector assembly 19 may contain a plurality of indexing slots 20 that engage a plurality of corresponding indexing ribs 3 when the cap 8 is attached to the caster body 2.

The side sections 21 and 21′ may comprise at least one detent element, such as detent elements 23 and 23′ (detent element 23′ not shown) for an interlocking or snapping-fitting connection with the indentions 4 of the caster body 2. The side sections 21 and 21′ may also comprise at least one vertical slot 22 to allow for an expansion of the connector assembly 19. In addition, the side sections 21 and 21′ may comprise at least one compression rib, such as vertical compression ribs 24a-24d (vertical compression ribs 24b-24d not shown) for compressing the caster body 2 to urge a snug fit between the connector assembly 19 and the caster body 2 when the caster body 2 is attached to the connector assembly 19. The at least one detent element and the at least one compression rib may be integrally formed with the connector assembly 19 or may be separate components, mounted to the connector assembly 19.

In the depicted embodiment, the detent elements 23 and 23′ are generally cylindrical and mate with corresponding indentions 4 in the caster body 2 that are generally rectangular. However, the detent elements 23 and 23′ and the indentions 4 may have any suitable configuration, as long as an interlocking or snap-fitting connection is achieved when the detent elements 23 and 23′ are engaged with corresponding caster body 2 indentions 4. For example, the detent elements 23 and 23′ may be generally semi-hemispherical and the caster body indentions may be generally circular.

One or more supports, such as supports 50a and 50b may also be provided between the inner surface 51 of the cap 8 and the front 30 and/or back 30′ section of the connector assembly 19 to inhibit the flexibility of the connector assembly 19 and urge a snug fit between the connector assembly 19 and the caster body 2.

As can be seen from the depicted embodiment of FIG. 4a, the cap 8 may be assembled on the caster body 2, by positioning the indexing rib 3 of the front edge 11 of the caster body 2 within the indexing slot 20 of the front section 30 of the connector assembly 19; positioning the indexing rib 3 of the back edge 12 of the caster body 2 within the indexing slot 20′ of the back section 30′ of the connector assembly 19; and applying a force, tending to bring the cap 8 and connector assembly 19 towards each other. When this relative motion is created, the vertical slots 22 allow the connector assembly 19 to circumferentially expand as the caster body 2 extends within the connector assembly 19, and substantially return to an initial position when the detent elements 23 and 23′ engage with corresponding indentions 4 on the caster body 2, such that an interlocking or snap-fitting connection is achieved between the detent elements 23 and 23′ and the corresponding indentions 4, and thus a snap-fitting connection is achieved between the connector assembly 19 and the caster body 2.

In a preferred embodiment, the detent elements 23 and 23′ are generally cylindrical and the indentions 4 are generally rectangular. When the detent elements 23 and 23, have a generally rounded surface, the detent elements 23 and 23′ may be disengaged from the corresponding indentions 4 by merely applying an appropriate force, such as a force substantially parallel to a sidewall of the connector assembly 19, tending to force the connector assembly 19 and the caster body 2 away from each other. In this manner, a caster cap, such as the cap 8, may be removably coupled to the caster body 2 and the caster cap 8 can be easily interchanged with other caster cap configurations.

FIG. 4c shows an underside perspective detailed view of the cap 8 of FIG. 4a.

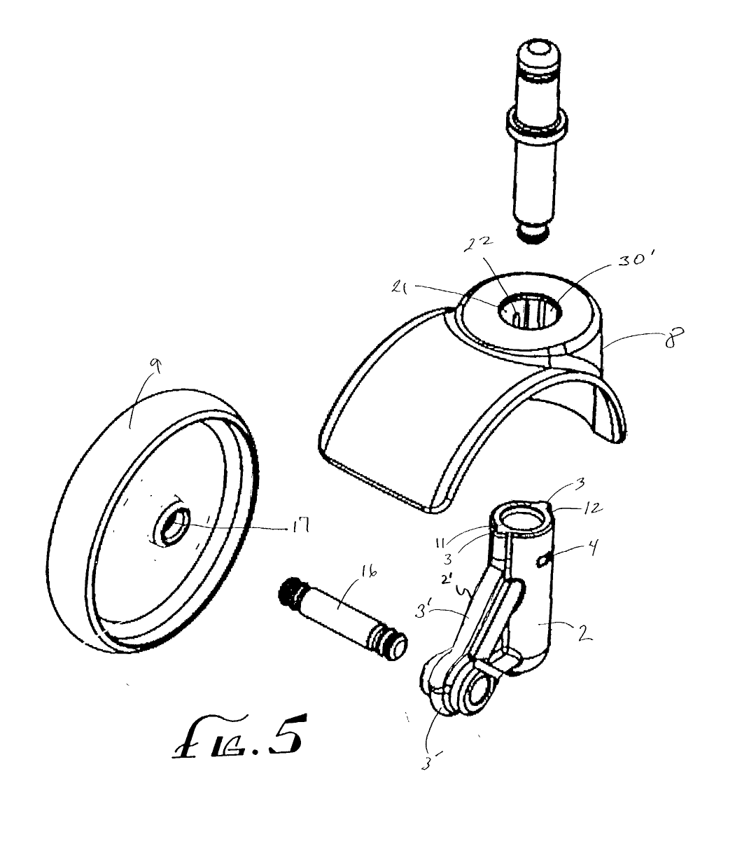

FIG. 5 shows a top exploded perspective view of an alternative embodiment of the caster assembly according to the present invention.

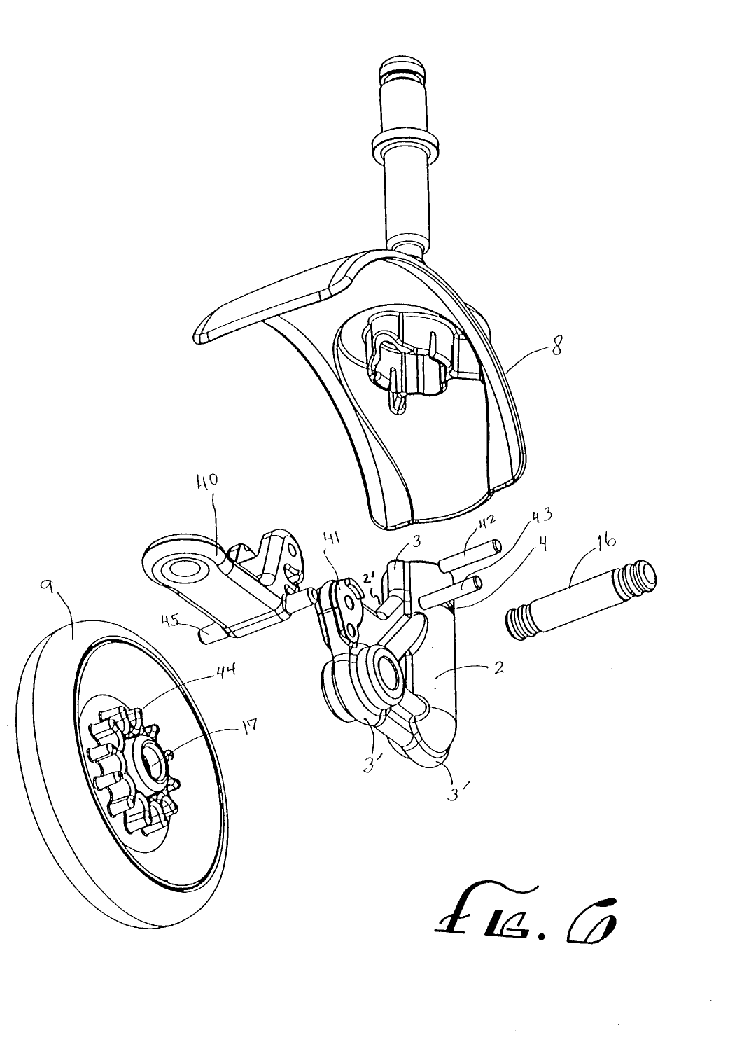

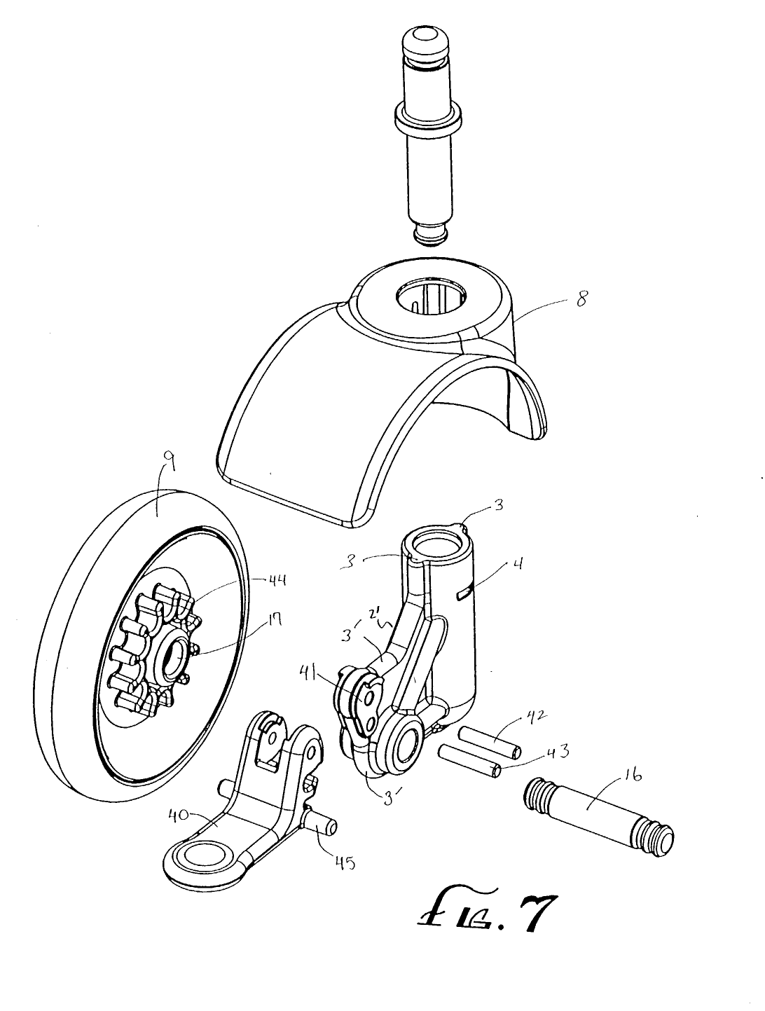

FIGS. 6 and 7 show a bottom and a top exploded perspective view, respectively, of another alternative caster assembly according to the present invention, wherein the caster body 2 further comprises a brake assembly, such as a brake assembly comprising a brake lever 40, a brake lever mounting portion 41, a braking dowel 45, a brake lever mounting dowel 42, a brake lever locking dowel 43, and a cogwheel 44 formed on an inner surface of the wheel 9, as is further disclosed in U.S. patent application Ser. No. ______ (attorney docket number H367-48515), entitled “CASTER BRAKE ASSEMBLY”, filed on even date herewith, the disclosure of which has been previously incorporated herein in full by reference.

Although the present invention has been described and illustrated with respect to a preferred embodiments thereof, it is to be understood that the invention is not to be limited since changes and modifications are within the intended scope of the invention as hereinafter claimed.

What is claimed is:

1. A caster assembly comprising:
at least one caster wheel;
a wheel axle attached to the at least one caster wheel;
a caster body having at least one cap-orientation indexing rib and at least one indention, wherein the wheel axle is attached to the caster body;
a connector assembly attached to the caster body, the connector assembly having at least one indexing slot for receiving the at least one indexing rib of the caster body and at least one detent element for forming an interlocking connection with the at least one indention of the caster body; and
a caster cap attached to the connector assembly.

2. The caster assembly of claim 1, wherein the connector assembly is removably coupled to the caster body, such that the caster cap is interchangeable with other caster caps.

3. The caster assembly of claim 1, wherein the at least one detent element of the connector assembly has at least one rounded surface, which enables the at least one detent element to be removably coupled to the at least one indention of the caster body.

4. The caster assembly of claim 1, wherein the connector assembly has at least one vertical slot to allow for an expansion of the connector assembly.

5. The caster assembly of claim 4, wherein the caster cap has at least one support, which inhibits the expansion of the connector assembly.

6. The caster assembly of claim 1, wherein the connector assembly has at least one compression rib, which compresses the caster body when the at least one detent element is interlockingly coupled to the at least one indention of the caster body, to urge a snug fit between the connector assembly and the caster body.

7. The caster assembly of claim 1, wherein the caster body has two indentions and the connector assembly has two detent elements, wherein each detent element forms an interlocking connection with a corresponding one of the two caster body indentions.

8. The caster assembly of claim 7, wherein the two caster body indentions are oppositely disposed on the caster body and wherein the two detent elements are oppositely disposed on the connector assembly.

9. The caster assembly of claim 1, wherein the at least one detent element is generally cylindrical and the at least one caster body indention is generally rectangular.

10. The caster assembly of claim 1, wherein the caster body has two indexing ribs and the connector assembly has two indexing slots, wherein each indexing rib mates with a corresponding one of the two indexing slots.

11. The caster assembly of claim 10, wherein the two indexing ribs are oppositely disposed on the caster body and wherein the two indexing slots are oppositely disposed on the connector assembly.

12. The caster assembly of claim 1, wherein the at least one indexing rib is generally cylindrical and the at least one indexing slot is generally cylindrical.

13. A caster assembly comprising:
at least one caster wheel;
a wheel axle attached to the at least one caster wheel;
a caster body having at least two cap-orientation indexing ribs and at least two indentions, wherein the wheel axle is attached to the caster body;
a connector assembly attached to the caster body, the connector assembly having at least two indexing slots and at least two detent elements, wherein each indexing slot receives a corresponding one of the at least two indexing ribs of the caster body and wherein each detect element forms an interlocking connection with a corresponding one of the at least two indentions of the caster body; and
a caster cap attached to the connector assembly.

14. The caster assembly of claim 13, wherein the connector assembly is removably coupled to the caster body, such that the caster cap is interchangeable with other caster caps.

15. The caster assembly of claim 13, wherein each of the at least two detent elements of the connector assembly has at least one rounded surface, which enables each of the at least two detent elements to be removably coupled to a corresponding one of the at least two indentions of the caster body.

16. The caster assembly of claim 13, wherein each of the at least two detent elements is generally cylindrical and each of the at least two caster body indentions is generally rectangular.

17. The caster assembly of claim 1, wherein each of the at least two indexing ribs is generally cylindrical and each of the at least two indexing slots is generally cylindrical.

18. A method for assembling a caster assembly comprising:
providing at least one caster wheel;
attaching the at least one caster wheel to a wheel axle;
attaching the wheel axle to a caster body, wherein the caster body has at least one cap-orientation indexing rib and at least one indention;
providing a caster cap having a connector assembly attached thereto, the connector assembly having at least one indexing slot for receiving the at least one indexing rib of the caster body and at least one detent element for forming an interlocking connection with the at least one indention of the caster body;
aligning the at least one indexing rib of the caster body with the at least one indexing slot of the connector assembly; and
displacing the at least one indexing rib of the caster body within the at least one indexing slot of the connector assembly until the at least one detent element of the connector assembly forms an interlocking connection with the at least one indention of the caster body.

19. The method of claim 18, further comprising:
replacing the caster cap with an interchangeable caster cap by disengaging the interlocking connection of the at least one detent element of the connector assembly and the at least one indention of the caster body; and
attaching the interchangeable caster cap to the caster body.

20. The method of claim 19, wherein the interlocking connection of the at least one detent element of the connector assembly and the at least one indention of the caster body is disengaged by applying a force that creates a relative motion between the caster cap and the caster body, such that the caster cap and caster body are displaced away from each other.

21. The method of claim 18, further comprising:
expanding the connector assembly during the displacing of the at least one indexing rib of the caster body within the at least one indexing slot of the connector assembly; and
returning the connector assembly substantially to a pre-expansion form when the at least one detent element of the connector assembly has formed an interlocking connection with the at least one indention of the caster body.

22. The method of claim 18, further comprising compressing the caster body with at least one compression rib, which is attached to the connector assembly, when the at least one detent element is interlockingly coupled to the at least one indention of the caster body, to urge a snug fit between the connector assembly and the caster body.

23. The method of claim 18, wherein the caster body has two indexing ribs and the connector assembly has two indexing slots, such that the method further comprises aligning each indexing rib with a corresponding one of the two indexing slots; and
displacing each indexing rib within the corresponding one of the two indexing slots until the at least one detent element of the connector assembly forms an interlocking connection with the at least one indention of the caster body.

24. The method of claim 18, wherein the caster body has two indentions and the connector assembly has two detent elements, such that the at least one indexing rib of the caster body is displaced within the at least one indexing slot of the connector assembly until each of the two detent elements of the connector assembly forms an interlocking connection with a corresponding one of the two indentions of the caster body.
